(19) United States
(12) Patent Application Publication
(10) Pub. No.: US 2011/0158238 A1
(43) Pub. Date: Jun. 30, 2011

(54) IP Cache

(75) Inventors: Dongren Chen, Shanghai (CN); Guang Hu, Shanghai (CN)

(73) Assignee: ARCSOFT (SHANGHAI) TECHNOLOGY COMPANY, LTD, Shanghai (CN)

(21) Appl. No.: 12/808,831

(22) PCT Filed: Dec. 19, 2007
(86) PCT No.: PCT/CN2007/003681

§ 371 Date: Sep. 9, 2010

(51) Int. Cl. H04L 12/56

(52) U.S. Cl. 370/392

(57) ABSTRACT

Each device (A, B) keeps an IP cache list storing IP address of devices it has communicated with in the past over an IP network (106). When the IP address of a device changes, it provides its new IP address to the devices in its IP cache list. As a result, any two devices that have communicated in the past are able to locate each other as long as their IP addresses do not change about the same time. A device can also provide its IP cache list to another device so the other device can query the devices in the IP cache list for the updated IP address of the device.

### CROSS REFERENCE TO RELATED APPLICATIONS

This application is related to (1) U.S. patent application Ser. No. 11/280,688, entitled “Using PSTN to Communicate IP Addresses for Point-To-Point Text, Voice, Video, or Data Communication,” Attorney Docket No. ARC-152, (2) U.S. patent application Ser. No. 11/618,741, entitled “Using Secondary Channels to Communicate IP Addresses for Point-To-Point Communication,” Attorney Docket No. ARC-165, and (3) U.S. application Ser. No. 11/618,739, entitled “Determining Pairings of Telephone Numbers and IP Addresses from Caching and Peer-to-Peer Lookup,” Attorney Docket No. ARC-P163, which are commonly assigned and incorporated herein by reference.

### FIELD OF INVENTION

This invention relates to methods for caching IP addresses of devices for point-to-point communication over a public computer network.

### DESCRIPTION OF RELATED ART

Voice over Internet Protocol (VoIP) is the routing of voice conversations over the Internet or through any other IP-based network. Companies providing VoIP service are commonly referred to as providers, and protocols which are used to carry voice signals over the IP network are commonly referred to as VoIP protocols. Some cost savings are due to utilizing a single network to carry voice and data, especially where users have existing underutilized network capacity that can carry VoIP at no additional cost. VoIP to VoIP phone calls are sometimes free, while VoIP to public switched telephone networks (PSTN) may have a cost that's borne by the VoIP user.

### BRIEF DESCRIPTION OF THE DRAWINGS

FIGS. 1 and 2 illustrate a system for point-to-point communication between devices in one embodiment of the invention.

FIG. 3 illustrates a system implementing IP address synchronization between devices in one embodiment of the invention.

FIGS. 4 and 5 are flowcharts of methods for the devices in the system of FIG. 3 to implement IP address synchronization in one embodiment of the invention.

FIG. 6 illustrates one variation of the system of FIG. 3 where the devices are VoIP devices in one embodiment of the invention.

FIG. 7 illustrates a system implementing a more robust IP address synchronization between devices in one embodiment of the invention.

FIGS. 8, 9, and 10 are flowcharts of methods for the devices in the system of FIG. 7 to implement IP address synchronization in one embodiment of the invention.

Use of the same reference numbers in different figures indicates similar or identical elements.

### SUMMARY

In one embodiment of the invention, each device keeps an IP cache list storing IP addresses of devices it has communicated with in the past over an IP network. When the IP address of a device changes, it provides its new IP address to the devices in its IP cache list. As a result, any two devices that have communicated in the past are able to locate each other as long as their IP addresses do not change about the same time.

In another embodiment of the invention, a first device provides its IP cache list to a second device so that the second device is able to locate the first device even if their IP addresses change about the same time. This is possible because the second device can query devices in the first device's IP cache list for the updated IP address of the first device.

### DETAILED DESCRIPTION

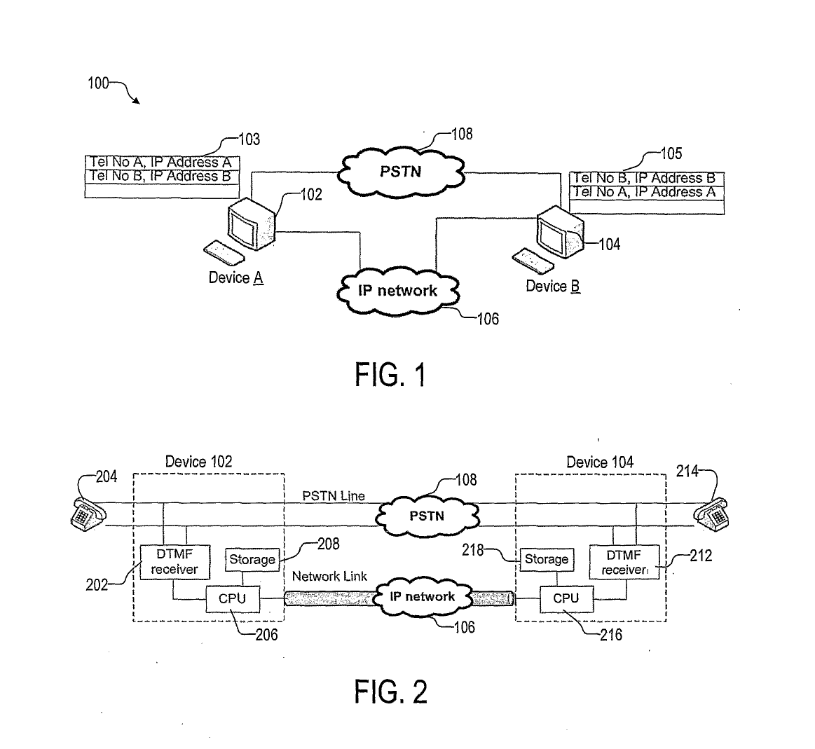

FIG. 1 illustrates a system 100 for establishing communication between VoIP devices 102 and 104 in one embodiment of the invention. VoIP devices 102 and 104 are connected by an Internet Protocol (IP) network 106 (e.g., the Internet) for exchanging data packets through a network connection. VoIP devices 102 and 104 are also connected by a secondary channel 108, such as a public switched telephone network (PSTN), to exchange IP addresses for establishing the network connection over IP network 106.

FIG. 2 illustrates additional details of VoIP devices 102 and 104 in one embodiment of the invention. VoIP device 102 includes a dual-tone multifrequency (DTMF) or frequency-shift keying (FSK) receiver 202 coupled to PSTN lines from a plain old telephone service (POTS) telephone 204 to PSTN 108. DTMF receiver 202 detects the telephone numbers dialed by the user. A processor 206 is coupled to DTMF receiver 202 to receive the telephone numbers dialed by the user. Processor 206 is also coupled to a memory 208 for storing a pairing list 103 (FIG. 1) with pairings of telephone numbers and IP addresses of various devices the user has previously called. Memory 208 also stores VoIP software executed by processor 206. Memory 208 can be a flash memory or a hard disk. In another embodiment, VoIP device 102 is integrated with POTS telephone 204 to have a form factor of a conventional telephone.

Similarly, VoIP device 104 includes a DTMF or FSK receiver 212 coupled to PSTN lines from a POTS telephone 214 to PSTN 108. A processor 216 is coupled to DTMF receiver 212 to receive the dialed telephone numbers. Processor 216 is also coupled to a memory 218 for storing a pairing list 105 (FIG. 1) with pairings of telephone numbers and IP addresses of various devices the user has previously called. Memory 218 also stores the VoIP software executed by processor 216. In another embodiment, VoIP device 104 is integrated with POTS telephone 214 to have a form factor of a conventional telephone.

Assume that the user at VoIP device 102 wishes to call the user at VoIP device 104. If the dialed number is in pairing list 103, VoIP device 102 then uses the IP address paired with the dialed number to establish an IP connection with VoIP device 104 over IP network 106 for a telephone call between the users. If the dialed number is not in its pairing list 103, VoIP device 102 can use a peer-to-peer lookup protocol with other VoIP devices to search for the IP address of VoIP device 104. If the dialed number is not found through the peer-to-peer lookup, VoIP device 102 can establish a telephone connection with VoIP device 104 over PSTN 108 to request the IP address of VoIP device 104.

The above described steps for discovering the IP address is somewhat complicated and slow, especially if the IP addresses of the VoIP devices change for any reason. Thus, what is needed is an improved method for VoIP devices to track IP addresses of their peers.

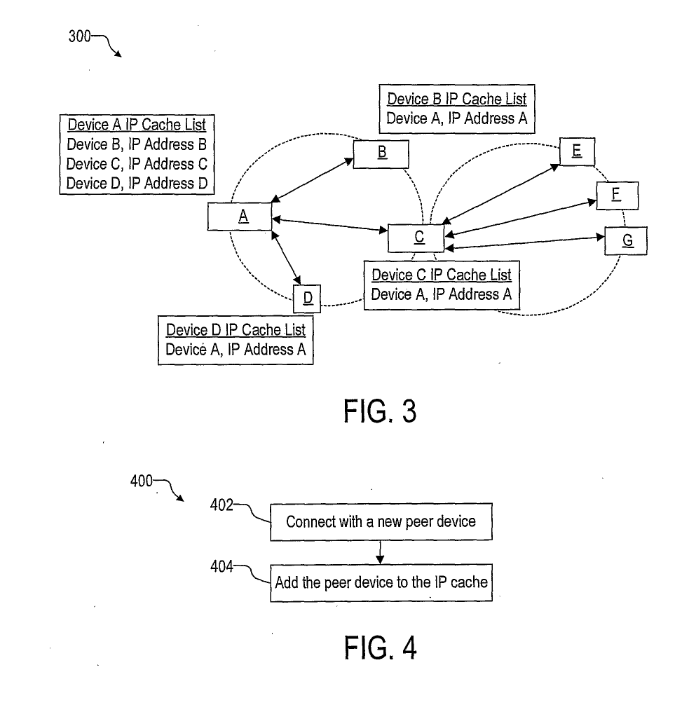

FIG. 3 illustrates a system 300 implementing IP address synchronization between devices in embodiments of the invention. In system 300, devices A, B, C, D, E, F, and G are devices that can connect to an IP network (e.g., the Internet). Device A has previously connected to devices B, C, and D over the IP network (as indicated by the solid doubled arrowed lines between them) and has cached the IP addresses of devices B, C, and D in its IP cache list. Caching refers to storing IP addresses that are often accessed and discards others that have not been accessed in a long time. Devices B, C, and D have also cached the IP address of device A in their respective IP cache lists.

Note that device A can initially obtain the IP address of devices B, C, and D in many ways. For example, device A can obtain the IP address of device B from a central server that registers the IP devices, a secondary channel (e.g., the PSTN) for exchanging IP addresses with device B, or a peer-to-peer lookup protocol to search for the IP address of device B as described in the related applications incorporated by reference.

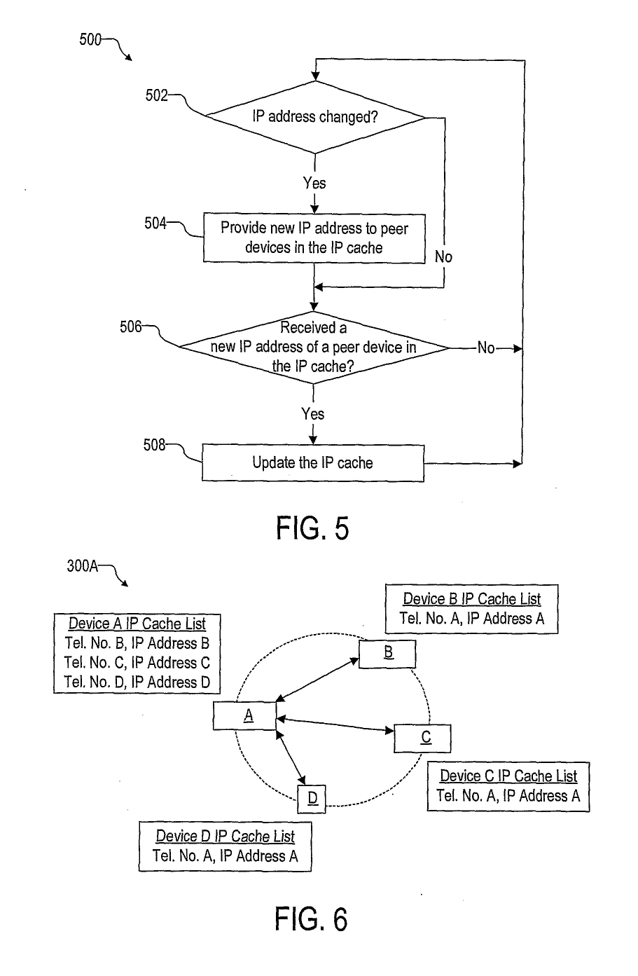

The IP address of a device can change for a variety of reasons. For example, the user can reset a static IP address, the user can obtain a new dynamic address, the user can power down a digital describer line (DSL) modem to break a DSL link, and a DSL provider may break a DSL link after a certain period of time. In system 300, each device provides its new IP address to the devices in its IP cache list. For example, when the IP address of device A changes, it provides its new IP address to devices B, C, and D in its IP cache list. Similarly, when the IP address of one of devices B, C, and D changes, the device provides its new IP address to device A in its IP cache list. Thus, unless the IP addresses of two devices change about the same time, they are able to locate each other as their IP addresses are synchronized. The above description also applies to device C that has previously connected to devices E, F, and G over the IP network. The IP address synchronization of system 300 is implemented with the methods shown in FIGS. 4 and 5.

FIG. 4 is a flowchart of a method 400 for device A to add a new device to its IP cache list in one embodiment of the invention.

In step 402, device A establishes an IP connection to a new device (e.g., device B) over an IP network. As device B is new to device A, device A first obtains the IP address of device B before establishing the IP connection. Step 402 is followed by step 404.

In step 404, device A adds the IP address of device B into its IP cache list for future lookup.

FIG. 5 is a flowchart of a method 500 for device A to synchronize IP addresses with its peer devices in one embodiment of the invention.

In step 502, device A determines if its IP address has changed. If so, then step 502 is followed by step 504. Otherwise step 502 is followed by step 506.

In step 504, device A sends over the IP network its new IP address to the peer devices in its IP cache list (e.g., devices B, C, and D) so they can update their IP cache lists with device A's new IP address. Step 504 is followed by step 506.

In step 506, device A determines if it has received over the IP network a new IP address from a peer device (e.g., device C) in its IP cache list. If so, then step 506 is followed by step 508. Otherwise step 506 is followed by step 502 and method 500 repeats as described above.

In step 508, device A updates its IP cache list with the new IP address of device C. Step 508 is followed by step 502 and method 500 repeats as described above.

FIG. 6 illustrates one embodiment of system 300 (hereafter “system 300A”) where devices A, B, C and D are VoIP devices. Devices A, B, C, and D may be implemented similar to VoIP devices 102 and 104 in FIGS. 1 and 2. In regards to method 400 (FIG. 4), VoIP device A initially obtains the IP addresses of VoIP devices B, C, and D and caches their IP addresses along with their corresponding telephone numbers in its IP cache list. For example, VoIP device A can obtain the IP address of VoIP device B, C, and D from a central server that registers the IP devices, a secondary channel (e.g., the PSTN) for exchanging IP addresses with device B, or a peer-to-peer lookup protocol to search for the IP address of device B as described in the related applications incorporated by reference. Subsequently when a user dials a telephone number, VoIP device A can look up the IP address paired with the dialed telephone number from the IP cache list to establish an IP connection to the appropriate VoIP device.

In regards to method 500 (FIG. 5), VoIP device A provides changes to its IP address to VoIP devices B, C, and D over the IP network. Alternatively, VoIP device A can provide its new IP address to VoIP devices B, C, and D over the PSTN using modem tones as described in the related applications incorporated by reference. Likewise, when any of VoIP devices B, C, and D changes its IP address, it provides its new IP address to VoIP device A over the IP network or the PSTN.

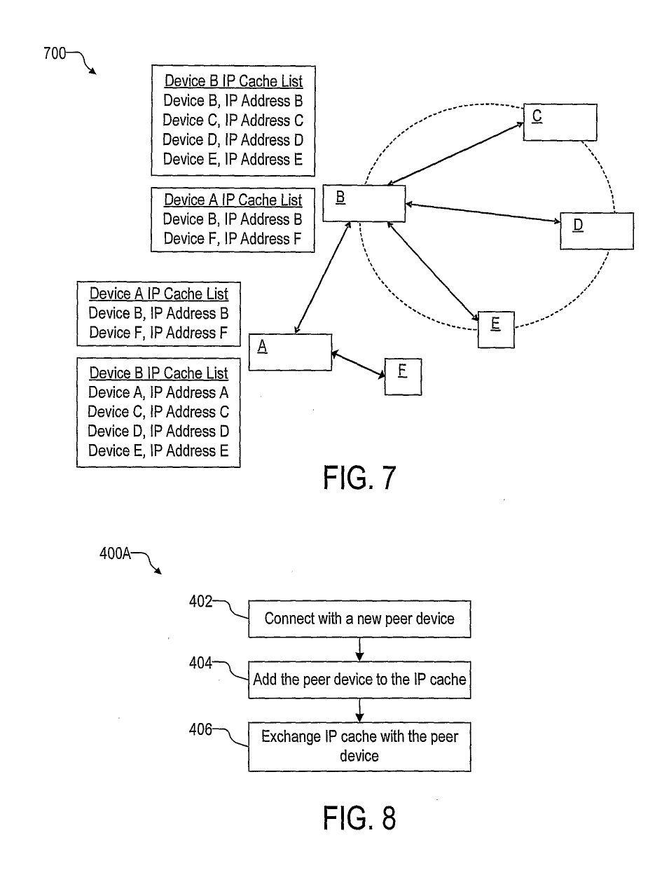

FIG. 7 illustrates a system 700 implementing IP address synchronization between devices in embodiments of the invention. In system 700, devices A, B, C, D, and E are devices that can connect to an IP network (e.g., the Internet). Device A has previously connected to devices B, C, D, and E over the IP network (as indicated by the solid doubled arrowed lines between them) and has cached the IP addresses of devices B, C, D, and E in its IP cache list. Devices B, C, D, and M have also cached the IP address of device A in their respective IP cache lists (for clarity only shown for device B in FIG. 7).

In system 700, devices A and B implement a more robust IP address synchronization so they are able to locate each other even when both devices change IP addresses about the same time. Specifically, device A provides its IP cache list to device B and updates any changes to its IP cache list with device M. Device B can also provide its IP cache list to device A and updates any changes to its IP cache list with device A. When the IP addresses of devices A and B change about the same time, they are not able to update the changes to each other. However, device B is able to query the devices in device A's IP cache list for device A's new IP address, and vice versa. This is possible as long as the devices in device A's IP cache list does not change their IP addresses about the same time as device A. Thus, the more devices are in the IP cache list of device A, the more likely devices A and B are able to relocate each other even if their IP addresses change about the same time. The robust IP address synchronization of system 700 is implemented with the methods shown in FIGS. 8, 9, and 10.

FIG. 8 is a flowchart of a method 400A for device B to add to its IP cache list a new device that desires a more robust IP address synchronization in one embodiment of the invention.

In step 402, device B establishes an IP connection to a new device (e.g., device A) over an IP network. Step 402 is followed by step 404.

In step 404, device B adds the IP address of device A into its IP cache list for future lookup. Step 402 is followed by step 406.

In step 406, device B sends its IP cache list to device A over the IP network, which device A stores in its memory. Likewise, device A can also send its IP cache list to device B over the IP network. Alternatively, devices A and B can exchange their IP cache list over a secondary channel (e.g., the PSTN).

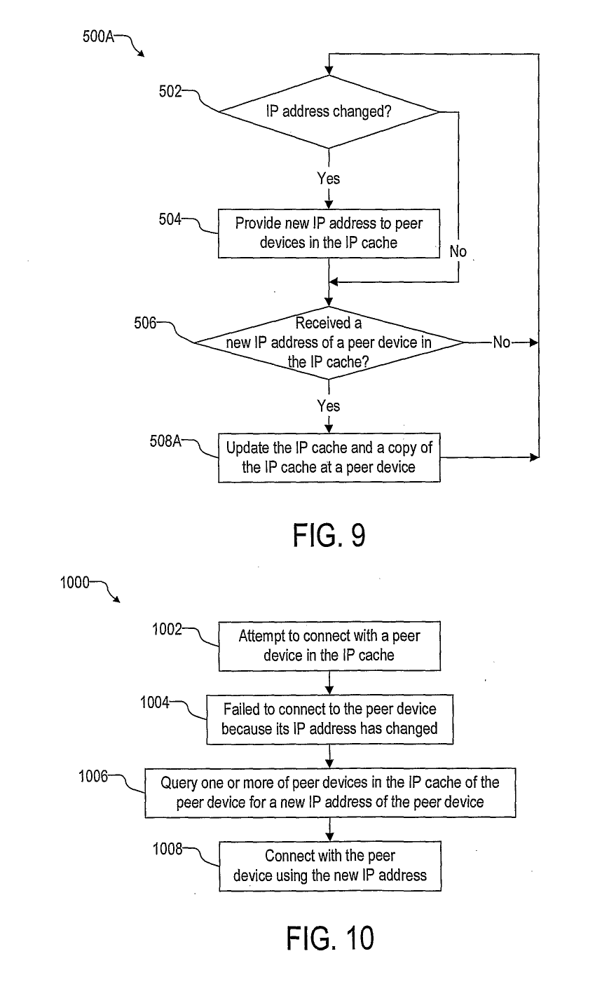

FIG. 9 is a flowchart of a method 500A for device B to robustly synchronize IP addresses with its peer devices in one embodiment of the invention.

In step 502, device B determines if its IP address has changed. If so, then step 502 is followed by step 504. Otherwise step 502 is followed by step 506.

In step 504, device B sends over the IP network its new IP address to the peer devices in its IP cache list (e.g., devices A, C, D, and E) so they can update their IP cache lists with the new IP address. Step 504 is followed by step 506.

In step 506, device B determines if it has received over the IP network a new IP address from a peer device (e.g., device C) in its IP cache list. If so, then step 506 is followed by step 508. Otherwise step 506 is followed by step 502 and method 500A repeats as described above.

In step 508A, device B updates its IP cache list with the new IP address of device C. Device B also updates the copy of its IP cache list stored at device A. Device B does this by transmitting the change to its IP cache list to device A over the IP network. Step 508A is followed by step 502 and method 500A repeats as described above.

Method 400A is similarly applied to device A. For example, device A receives an update to the IP address of a device F in its IP cache list. In response, device A updates the copy of its IP cache list stored at device B with the new IP address of device F.

FIG. 10 is a flowchart of a method 1000 for device A to establish an IP connection to device B after both devices change their IP addresses about the same time in one embodiment of the invention.

In step 1002, device A attempts to connect to device B over the IP network. Step 1002 is followed by step 1004.

In step 1004, device A realizes that it is unable to connect to device B over the IP network because the IP address of device B has changed. Step 1004 is followed by step 1006.

In step 1006, device A queries one or more devices (e.g., devices C, D, and E) in the IP cache list of device B, over the computer network, for the IP address of device B. Step 1006 is followed by step 1008.

In step 1008, device A uses the IP address returned from the one or more devices in the IP cache list of device B to connect to device B over the IP network.

Various other adaptations and combinations of features of the embodiments disclosed are within the scope of the invention. Numerous embodiments are encompassed by the following claims.

What is claimed is:

1. A method for a first device (A) to synchronize Internet Protocol (IP) addresses with other devices, comprising:
receiving an IP address of a second device (B) from the second device;
caching the IP address of the second device in an IP cache list of the first device;
detecting a change to an IP address of the first device; and
providing an updated IP address of the first device to the second device.

2. The method of claim 1, wherein said receiving an IP address of the second device (B) from the second device comprises receiving the IP address of the second device through one of a central server, a telephone connection to the second device, and peer-to-peer lookup through other devices.

3. The method of claim 1, wherein said providing an updated IP address of the first device (A) to the second device (B) comprises transmitting the updated IP address of the first device to the second device over one of an IP network (106) and a telephone network (108).

4. The method of claim 1, further comprising:
receiving an updated IP address of the second device (B) from the second device; and
updating the IP cache list of the first device (A) with the updated IP address of the second device.

5. The method of claim 4, wherein said receiving an updated IP address of the second device (B) from the second device comprises receiving the updated IP address of the second device over one of an IP network (106) and a telephone network (108).

6. The method of claim 1, wherein:
the first and the second devices (A, B) are Voice over Internet Protocol (VoIP) devices; and
said caching the IP address of the second device in an IP cache list of the first device comprises caching the IP address of the second device with a corresponding telephone number of the second device in the IP cache list of the first device.

7. The method of claim 6, further comprising:
detecting a user dialing the telephone number of the second device (B);
in response to said detecting, searching the IP address of the second device in the IP cache list of the first device (A) based on the telephone number of the second device; and
connecting to the second device over an IP network using the IP address of the second device.

8. The method of claim 1, further comprising receiving an IP cache list of the second device (B) from the second device, wherein the IP cache list of the second device includes an IP address of a third device (C; D; E) that has previously connected to the second device over an IP network.

9. The method of claim 8, further comprising:
querying the third device (C; D; E) for an updated IP address of the second device (B); and
connecting with the second device using the updated IP address of the second device.

10. The method of claim 1, further comprising providing the IP cache list of the first device (A) to the second device (B), wherein the IP cache list of the first device further includes an IP address of a third device (E) that has previously connected to the first device over an IP network.

11. The method of claim 10, further comprising:
receiving an updated IP address of the third device (F) from the third device; and
updating the IP cache list of the first device stored at the first device (A) and at the second device (B).

12. A method for a first device (A) to synchronize IP addresses with other devices, comprising:
receiving an IP cache list of a second device (B) from the second device, the IP cache list of the second device includes an IP address of a third device (C; D; E) that has connected to the second device over an IP network (106);
querying the third device for an updated IP address of the second device; and
connecting with the second device using the updated IP address of the second device.

13. The method of claim 12, further comprising:
receiving an updated IP address of the third device (C; D; F) from the second device (B); and
updating the IP cache list of the second device stored at the first device (A) with the updated IP address of the third device.

14. The method of claim 13, further comprising:
receiving an IP address of the second device (B) from the second device;
caching the IP address of the second device in an IP cache list of the first device (A).

15. The method of claim 14, further comprising:
detecting a change to an IP address of the first device (A); and
providing an updated IP address of the first device to the second device (B).
